(19) United States
(12) Patent Application Publication
(10) Pub. No.: US 2026/0268693 A1
(43) Pub. Date: Sep. 10, 2026

(54) TRAVELING CONTROL DEVICE, TRAVELING CONTROL METHOD, AND STORAGE MEDIUM

(71) Applicant: HONDA MOTOR CO., LTD., Tokyo (JP)

(72) Inventor: Daichi Inoue, Tokyo (JP)

(21) Appl. No.: 19/551,647

(22) Filed: Feb. 27, 2026

(30) Foreign Application Priority Data
Mar. 7, 2025 (JP) 2025-036326

(51) Int. Cl. G06V 20/56; B60W 30/12; G01S 7/02

(52) U.S. Cl. CPC G06V 20/588; B60W 30/12; G01S 7/021; B60W 2420/403; B60W 2420/408; B60W 2530/201; B60W 2552/53; B60W 2556/40

(57) ABSTRACT

A traveling control device of an embodiment includes a recognizer that recognizes a first partition line based on an captured image, a second partition line based on map information, and a target marker around a vehicle, a determiner that determines whether the first partition line and the second partition line match, a selector that selects any one of the first and the second partition line when it is determined that they do not match, and a traveling controller that executes traveling control of the vehicle based on the selected partition line, wherein the selector determines reliability of each of the first and the second partition line according to whether a stationary target marker recognized by the recognizer is present on a first lane partitioned and a second lane partitioned, and selects any one of the first partition line and the second partition line based on the reliability.

### CROSS-REFERENCE TO RELATED APPLICATION

Priority is claimed on Japanese Patent Application No. 2025-036326, filed Mar. 7, 2025, the content of which is incorporated herein by reference.

### BACKGROUND

### Field of the Invention

The present invention relates to a traveling control device, a traveling control method, and a storage medium.

### Description of Related Art

In recent years, there have been increasing attempts to provide access to a sustainable transportation system that takes into consideration the most vulnerable traffic participants. For this realization, research and development efforts are focused on further improving the safety and convenience of transportation through research and development related to automated driving technology. In this regard, a conventional technology is known for determining a lateral position of a vehicle using at least one of the lateral position of the vehicle based on satellite information and map information and the lateral position of the vehicle based on camera information, and calculating a target steering angle based on the determined lateral position of the vehicle and a curvature of a travel lane at a position of the vehicle (for example, Japanese Patent Publication No. 6415629). Further, in the past, there was also known technology that instructs a vehicle to modify route parameters when it is determined that the vehicle interferes with a road surface pattern, and prohibits or cancels a lane change when it is determined that the interference with the road surface pattern will occur even after modification up to a limit of modifiability of a section (for example, Japanese Patent Publication No. 6294928).

### SUMMARY

By the way, in the conventional automated driving technology, when a partition line for vehicle traveling control is selected based on partition lines obtained from the map information and partition lines obtained from a an output of camera, the selection method differs depending on comparison results between the partition lines, locations of nearby target markers, and the like, but there are some aspects that have not been fully considered, and there is still room for further investigation. Therefore, in accordance with results of recognition of surrounding situation, there was a problem that appropriate traveling control could not be executed.

In order to solve the above problem, an object of the present application is to provide a traveling control device, a traveling control method, and a storage medium capable of executing more appropriate traveling control based on the results of recognition of the surrounding situation. Then, this will ultimately contribute to the development of a sustainable transportation system.

A traveling control device, a traveling control method, and a storage medium according to this invention adopt the following configurations.
(1): A traveling control device according to an aspect of this invention is a traveling control device including a first recognizer configured to recognize a surrounding situation including a first partition line that partitions a lane around a vehicle from an image captured by an imaging part, a second recognizer configured to recognize a second partition line that partitions a lane around the vehicle from map information on the basis of position information of the vehicle, a third recognizer configured to recognize a target marker around the vehicle on the basis of an output of a radar device, a determiner configured to determine whether or not the first partition line and the second partition line match, a selector configured to select any one of the first partition line and the second partition line when the determiner determines that the first partition line and the second partition line do not match, and a traveling controller configured to execute traveling control of the vehicle on the basis of the partition line selected by the selector, wherein the selector determines a reliability of each of the first partition line and the second partition line according to whether or not a stationary target marker recognized by the third recognizer is present on a first lane partitioned by the first partition line and a second lane partitioned by the second partition line, and selects any one of the first partition line and the second partition line on the basis of the reliability.
(2): In the aspect of (1) described above, after it is determined that the reliability of the second partition line is less than a threshold value, the selector may determine that a determination that the reliability of the second partition line is less than the threshold value is correct when the stationary target marker is present outside an effective recognition range of the first recognizer and the stationary target marker is present on a lane partitioned by a virtual line that extends from a far end portion of the first partition line when seen from the vehicle.
(3): In the aspect of (2) described above, after it is determined that the reliability of the second partition line is less than the threshold value, the selector may determine that the determination that the reliability of the second partition line is less than the threshold value is erroneous when the stationary target marker is present within the effective recognition range of the first recognizer.
(4): In the aspect of (1) described above, the selector may determine that the second partition line is likely to be correct when the stationary target marker is present within an effective recognition range of the first recognizer, and determine that the second partition line is likely to be erroneous when the stationary target marker is present outside the effective recognition range of the first recognizer and the stationary target marker is present on a lane partitioned by a virtual line that extends from a far end portion of the first partition line when seen from the vehicle.
(5): In the aspect of (1) described above, the selector may set a determination target distance for determining whether or not the stationary target marker is present in the second partition line to be the same as a distance corresponding to an effective recognition range of the first recognizer when whether or not the stationary target marker recognized by the third recognizer is present on the first lane and the second lane is determined.
(6): In the aspect of (5) described above, when the distance corresponding to the effective recognition range of the first recognizer is less than a predetermined distance, the selector may set the determination target distance to be equal to or greater than the predetermined distance.
(7): In the aspect of (1) described above, in a case in which whether or not the stationary target marker recognized by the third recognizer is present on the first lane and the second lane, the selector may determine that the stationary target marker is present on the first lane when whether or not the stationary target marker is present on the first lane is determined and the stationary target marker is present within a range of a lane width of the first lane, and determine that the stationary target is present on the second lane when whether or not the stationary target is present on the second lane is determined and the stationary target marker is present within a range of a vehicle width of the vehicle.
(8): In the aspect of (7) described above, the range of the lane width may be a range offset by half a value of the lane width from a center of the first lane partitioned by the first partition line, and the range of the vehicle width of the vehicle may be a range offset by half a value of the vehicle width from a center of the second lane partitioned by the second partition line.
(9): In the aspect of (1) described above, the third recognizer may repeatedly recognize the stationary target marker at a predetermined cycle, and dismiss presence of the stationary target marker when the number of times that the reliability of the recognized stationary target marker is determined to be less than a threshold value reaches a predetermined number greater than 0, and the selector may determine the reliability of the first partition line and the second partition line on the basis of the stationary target marker after a predetermined period has elapsed since the stationary target marker is recognized by the second recognizer, and use the stationary target marker to determine the reliability of the first partition line and the second partition line when the number of times that the reliability of the stationary target marker is determined to be less than a threshold value is less than a predetermined number after the predetermined period has elapsed, and when it is determined that the reliability of the stationary target marker is equal to or greater than a threshold value after the predetermined period has elapsed,
(10): A traveling control method according to an aspect of this invention is a traveling control method including recognizing, by a computer, a surrounding situation including a first partition line that partitions a lane around a vehicle from an image captured by an imaging part, recognizing, by the computer, a second partition line that partitions a lane around the vehicle from map information on the basis of position information of the vehicle, recognizing, by the computer, a target marker around the vehicle on the basis of an output of a radar device, determining, by the computer, whether or not the first partition line and the second partition line match, selecting, by the computer, any one of the first partition line and the second partition line when it is determined that the first partition line and the second partition line do not match, executing, by the computer, traveling control of the vehicle on the basis of the selected partition line, and determining, by the computer, a reliability of each of the first partition line and the second partition line according to whether or not a stationary target marker is present on a first lane partitioned by the first partition line and a second lane partitioned by the second partition line, and selecting, by the computer, any one of the first partition line and the second partition line on the basis of the reliability.
(11): A storage medium according to an aspect of this invention is a computer-readable non-transitory storage medium storing a program causing a computer to: recognize a surrounding situation including a first partition line that partitions a lane around a vehicle from an image captured by an imaging part, recognize a second partition line that partitions a lane around the vehicle from map information on the basis of position information of the vehicle, recognize a target marker around the vehicle on the basis of an output of a radar device, determine whether or not the first partition line and the second partition line match, select any one of the first partition line and the second partition line when it is determined that the first partition line and the second partition line do not match, execute traveling control of the vehicle on the basis of the selected partition line, and determine a reliability of each of the first partition line and the second partition line according to whether or not a stationary target marker is present on a first lane partitioned by the first partition line and a second lane partitioned by the second partition line, and select any one of the first partition line and the second partition line on the basis of the reliability.

According to the aspects (1) to (11), it is possible to execute more appropriate traveling control based on the results of recognition of surrounding situation.

### BRIEF DESCRIPTION OF THE DRAWINGS

FIG. 1 is a configuration diagram of a vehicle system including a traveling control device according to an embodiment.

FIG. 2 is a functional configuration diagram of a first controller and a second controller.

FIG. 3 is a diagram for describing an example of traveling control of a vehicle according to the embodiment.

FIG. 4 is a diagram showing an example of a first scene of a surrounding situation.

FIG. 5 is a diagram showing an example of a second scene of the surrounding situation.

FIG. 6 is a diagram showing an example of a third scene of the surrounding situation.

FIG. 7 is a flowchart showing an example of a flow of a process executed by an automated driving control device.

### DESCRIPTION OF EMBODIMENTS

Hereinafter, a traveling control device, a traveling control method, and a storage medium according to an embodiment of the present invention will be described with reference to the accompanying drawings. In the following, an embodiment in which the traveling control device is applied to an automated driving vehicle will be described as an example. Automated driving refers to automatically controlling one or both of steering and a speed of a vehicle to execute traveling control, for example. Examples of the above-described traveling control may include traveling control such as an Adaptive Cruise Control System (ACC), Traffic Jam Pilot (TJP), Lane Keeping Assistance System (LKAS), Automated Lane Change (ALC), and Collision Mitigation Brake System (CMBS). Further, in the automated driving vehicle, traveling control according to a manual operation (so-called manual driving) of a user (for example, an occupant) of the vehicle may be executed. In the following description, a case will be described in which left-hand driving regulations are applied, but when right-hand driving regulations are applied, left and right may be read in reverse.

### Overall configuration

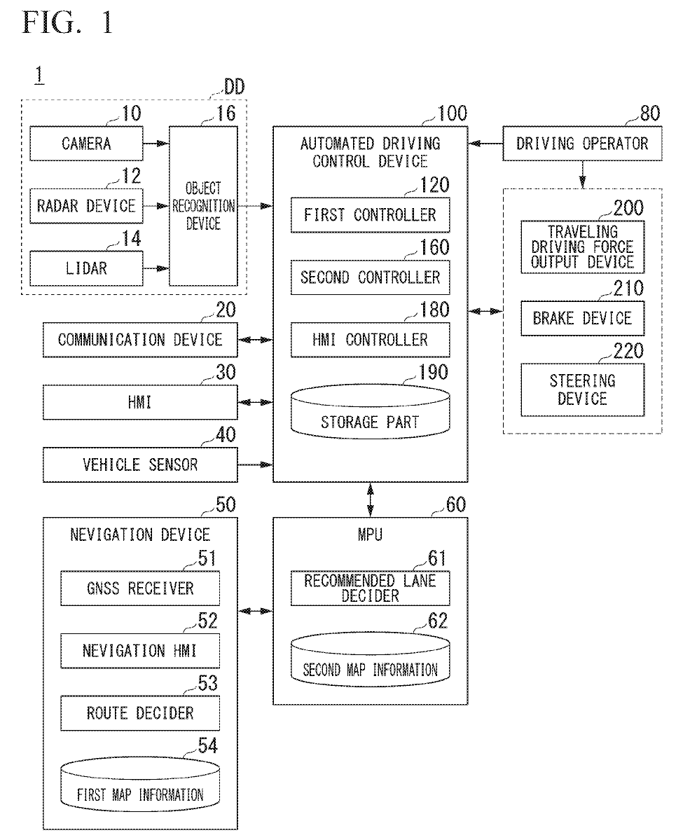

FIG. 1 is a configuration diagram of a vehicle system 1 including a traveling control device according to the embodiment. A vehicle (hereinafter, referred to as a vehicle M) in which the vehicle system 1 is mounted is, for example, a vehicle such as a two-wheeled vehicle, a three-wheeled vehicle, or a four-wheeled vehicle, and a drive source thereof is an internal combustion engine such as a diesel engine or a gasoline engine, an electric motor, or a combination thereof. The electric motor operates using electric power generated by a power generator connected to the internal combustion engine or electric power that is supplied when a secondary battery (a power storage) or a fuel cell is discharged.

The vehicle system 1 includes, for example, a camera 10, a radar device 12, a light detection and ranging (LIDAR) 14, an object recognition device 16, a communication device 20, a human machine interface (HMI) 30, a vehicle sensor 40, a navigation device 50, a map positioning unit (MPU) 60, a driving operator 80, an automated driving control device 100, a traveling driving force output device 200, a brake device 210, and a steering device 220. These devices and equipment are connected to each other by multiple communication lines, such as a controller area network (CAN) communication line, serial communication lines, wireless communication networks, or the like. Further, the configuration shown in FIG. 1 is merely an example, and some of the configuration may be omitted, or other configurations may be added. The camera 10 is an example of an “imaging part.” A combination of the camera 10, the radar device 12, the LIDAR 14, and the object recognition device 16 is an example of a “detection device DD.” The HMI 30 is an example of an "output device." The automated driving control device 100 is an example of a “traveling control device”.

For example, the camera 10 is a digital camera using a solid-state imaging element such as, for example, a charge-coupled device (CCD) or a complementary metal oxide semiconductor (CMOS). The camera 10 is mounted at any location on the vehicle M in which the vehicle system 1 is mounted. For example, when the view in front of the vehicle M is imaged, the camera 10 is mounted on an upper portion of a front windshield, a rear surface of a rearview mirror, a front portion of a vehicle body, or the like. When the view behind the vehicle M is imaged, the camera 10 is mounted on an upper portion of a rear windshield, a back door, or the like. When the view to the side of the vehicle M is imaged, the camera 10 is mounted on a door mirror, or the like. The camera 10 captures images of the surrounding situations of the vehicle M repeatedly, for example, periodically. The camera 10 may also be a stereo camera.

The radar device 12 emits radio waves such as millimeter waves around the vehicle M and detects radio waves (reflected waves) reflected by nearby objects to detect at least positions (distances and orientations) of the objects. The radar device 12 is mounted on the vehicle M at an arbitrary location. The radar device 12 may detect the position and speed of the object using a frequency modulated continuous wave (FM-CW) method.

The LIDAR 14 radiates light to the vicinity of the vehicle M and measures scattered light. The LIDAR 14 detects a distance to a subject on the basis of a time between light emission and reception. The emitted light is, for example, a pulsed laser beam. The LIDAR 14 is mounted at an arbitrary position of the vehicle M.

The object recognition device 16 executes a sensor fusion process on some or all of the detection results from the camera 10, the radar device 12, and the LIDAR 14 to recognize the position, type, speed, and the like of the object. The object recognition device 16 outputs the recognition results to the automated driving control device 100. Further, the object recognition device 16 may output the detection results of the camera 10, the radar device 12, and the LIDAR 14 to the automated driving control device 100 as they are. In this case, the object recognition device 16 may be omitted from a configuration of the vehicle system 1 (the detection device DD).

The communication device 20 communicates with, for example, other vehicles present around the vehicle M, a terminal device of a user using the vehicle M, or various server devices using, for example, a network such as a cellular network, a Wi-Fi network, a Bluetooth (a registered trademark), dedicated short range communication (DSRC), a local area network (LAN), a wide area network (WAN), or the Internet.

The HMI 30 outputs various types of information to the occupant of the vehicle M and receives input operations by the occupant. The HMI 30 includes, for example, various display devices, speakers, buzzers, touch panels, switches, keys, and microphones.

The vehicle sensor 40 includes a vehicle speed sensor that detects the speed of the vehicle M, an acceleration sensor that detects an acceleration, a yaw rate sensor that detects a yaw rate (for example, a rotational angular velocity around a vertical axis passing through the center of gravity of the vehicle M), a direction sensor configured to detect the direction of the vehicle M, and the like. The vehicle sensor 40 may also be provided with a position sensor that detects the position of the vehicle. The position sensor is, for example, a sensor that acquires position information (longitude and latitude information) from a global positioning system (GPS) device. Further, the position sensor may be a sensor that acquires position information using a global navigation satellite system (GNSS) receiver 51 of the navigation device 50. The vehicle sensor 40 may derive the speed of the vehicle M from a difference (that is, a distance) in the position information at a predetermined time in the position sensor. A detection result of the vehicle sensor 40 is output to the automated driving control device 100.

The navigation device 50 includes, for example, a GNSS receiver 51, a navigation HMI 52, and a route decider 53. In the navigation device 50, first map information 54 is retained in a storage device such as a hard disk drive (HDD) or a flash memory. The GNSS receiver 51 specifies a position of the vehicle M on the basis of the signal received from a GNSS satellite. The position of the vehicle M may be specified or supplemented by an inertial navigation system (INS) using the output of the vehicle sensor 40. The navigation HMI 52 includes a display device, a speaker, a touch panel, and keys. The GNSS receiver 51 may be provided in the vehicle sensor 40. The navigation HMI 52 may be partially or completely shared with the HMI 30 described above. The route decider 53 determines, for example, a route (hereinafter, a route on map) to a destination input by an occupant using the navigation HMI 52 from a position of the vehicle M (or an arbitrary position that was input) specified by the GNSS receiver 51 with reference to the first map information 54. The first map information 54 is, for example, information that represents a shape of a road using links that indicate roads and nodes connected by the links. The first map information 54 may include point of interest (POI) information, and the like. The route on map is output to the MPU 60. The navigation device 50 may execute route guidance using the navigation HMI 52 on the basis of the route on map. The navigation device 50 may transmit the current position and destination to a navigation server via the communication device 20, and acquire the same route as the route on map from the navigation server. The navigation device 50 outputs a decided route on the map to the MPU 60.

The MPU 60 includes, for example, a recommended lane decider 61 and stores second map information 62 in a storage device such as an HDD or a flash memory. The recommended lane decider 61 divides the route on the map provided from the navigation device 50 into a plurality of blocks (for example, divides the route every 100 [m] in a traveling direction of the vehicle), and decides a recommended lane for each block with reference to the second map information 62. The recommended lane decider 61 determines which lane from the left the vehicle travels on. When there is a branching point in the route on a map, the recommended lane decider 61 determines the recommended lane such that the vehicle M travels along a rational route for traveling to a branching destination.

The second map information 62 is map information more accurate than the first map information 54. The second map information 62 includes, for example, the number of lanes, types and shapes of road partition lines (hereinafter, referred to as partition lines), information on centers of lanes, and information on road boundaries. The second map information 62 may include information indicating whether or not the road boundary is a boundary including a structure through which the vehicle M cannot pass (including cross or contact). The structure is, for example, a guardrail, a curbstone, a median, and a fence. “Cannot pass through” may include the presence of a step that is so low that the vehicle can pass when a vibration of the vehicle that cannot normally occur is allowed. Further, the second map information 62 may include road shape information, traffic regulation information, address information (address and zip code), facility information, parking lot information, telephone number information, and the like. The road shape information includes, for example, a curvature of the road (which may be rephrased as the radius of curvature; the same applies below), an amount of change in the curvature per predetermined distance, a width, a gradient, and the like.

The second map information 62 may also include information on a line (a median line) indicating the center of the lane. The median line is a center line between left and right partition lines. This median line may be present in a lane in which any one of left and right partition lines that partition the lane is interrupted. The second map information 62 may also store information on road branch points, merging points, lane increase/decrease points, and the like. The branch point may include information on a branch lane and a main line, and the merging point may include information on a merging lane and a main line. Further, the second map information 62 may include information on the location, type, and shape of structures (structures that do not obstruct driving) such as elevated roads, pedestrian bridges, and tunnels that cross over the lanes without touching them.

The second map information 62 may be updated at any time by the communication device 20 communicating with an external device. The first map information 54 and the second map information 62 may be integrally provided as map information. The map information may also be stored in a storage part 190.

The driving operator 80 includes, for example, a steering wheel, an accelerator pedal, and a brake pedal. Further, the driving operator 80 may include a shift lever, a differential steering wheel, a joystick, or other operators. An operation detector that detects an amount of operation with respect to the operator by the occupant or presence or absence of the operation, for example, is mounted in each operator of the driving operator 80. The operation detector detects, for example, a steering angle or steering torque of the steering wheel, and an amount of depression of the accelerator pedal or the brake pedal. The operation detector outputs detection result to one or both of the automated driving control device 100, and the traveling driving force output device 200, the brake device 210 and the steering device 220.

The automated driving control device 100 executes various driving controls relating to automatic driving for the vehicle M. The automated driving control device 100 includes, for example, a first controller 120, a second controller 160, an HMI controller 180, and the storage part 190. The first controller 120, the second controller 160, and the HMI controller 180 are realized, for example, by causing a hardware processor such as a central processing unit (CPU) to execute a program (software). Further, some or all of these components may be realized by hardware (including circuitry) such as a large scale integration (LSI), an application specific integrated circuit (ASIC), a field-programmable gate array (FPGA), a graphics processing unit (GPU), or a system on chip (SOC), or may be realized by a combination of software and hardware. The program may be pre-stored in a storage device (a storage device including a non-transitory storage medium) such as an HDD or a flash memory of the automated driving control device 100 or may be stored in a removable storage medium such as a DVD, a CD-ROM, or a memory card and installed in the storage device of the automated driving control device 100 when the storage medium (the non-transitory storage medium) is mounted in a drive device, a card slot, or the like.

The storage part 190 may be implemented by the above-described various storage devices an electrically erasable programmable read-only memory (EEPROM), a read-only memory (ROM), a random-access memory (RAM), or the like. The storage part 190 stores, for example, various types of information, programs, and the like in the embodiment. Further, the storage part 190 may store map information (for example, the first map information 54 and the second map information 62).

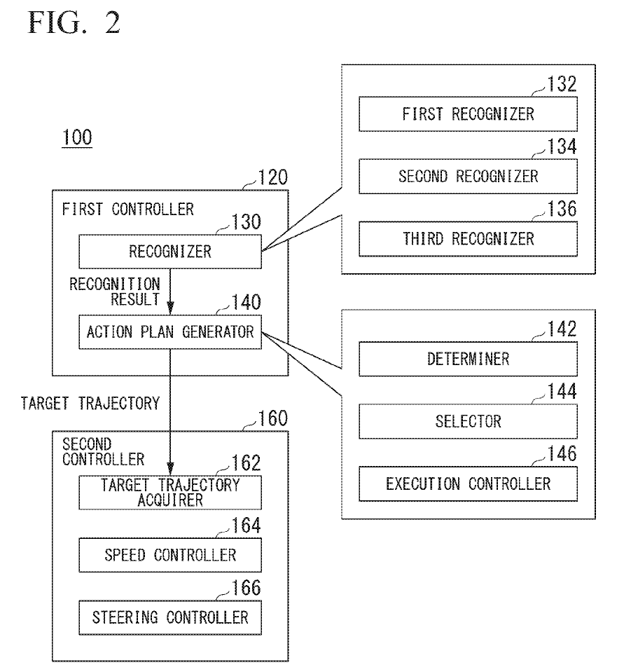

FIG. 2 is a functional configuration diagram of the first controller 120 and the second controller 160. The first controller 120 includes, for example, a recognizer 130 and an action plan generator 140. The first controller 120 executes functions based on, for example, artificial intelligence (AI) and a pre-defined model in parallel. For example, a function of “recognizing an intersection” may be realized by executing in parallel recognition of an intersection by deep learning or the like and recognition based on pre-defined conditions (such as signals and road signs that can be pattern matched), and by scoring and comprehensively evaluating both. Accordingly, a reliability of automated driving is guaranteed. Further, the first controller 120 executes control relating to automated driving of the vehicle M on the basis of, for example, instructions from the MPU 60, the HMI controller 180, or the like.

The recognizer 130 recognizes a surrounding situation of the vehicle M on the basis of a recognition result of the detection device DD (information input from the camera 10, the radar device 12, and the LIDAR 14 via the object recognition device 16). For example, the recognizer 130 recognizes a state such as a position, speed, acceleration of target markers (objects) present around the vehicle M (within a predetermined distance). The target markers include, for example, stationary and moving target markers. The stationary target markers include, for example, road structures such as road signs, traffic lights, railroad crossings, curbstones, medians, guardrails, and fences, as well as obstacles (for example, fallen objects) that cannot move on their own. Furthermore, the stationary target markers are not limited to objects installed on the lanes (adjacent to the lanes), but may also include structures such as elevated roads, pedestrian bridges, and tunnels that are installed across the lanes. The moving objects include, for example, other vehicles (surrounding vehicles) and objects that can move by themselves, such as traffic participants (bicycles, pedestrians, or the like) traveling on the road. The positions of the target markers are, for example, recognized as positions on an absolute coordinate system with a representative point (such as a center of gravity or a center of a driving shaft) of the vehicle M as an origin, and are used for control. The position of the target marker may be represented by a representative point such as the center of gravity or a corner of the target marker, or may be represented by a represented region. When the target marker is a moving target marker such as another vehicle, the “state” of the target marker may include, for example, acceleration or jerk of the moving target marker, or a “action state” (for example, whether the other vehicle is changing lanes or is about to change lanes).

Further, the recognizer 130 includes, for example, a first recognizer 132, a second recognizer 134, and a third recognizer 136 . Details of functions thereof will be described below.

The action plan generator 140 generates an action plan for driving the vehicle M by automated driving based on the recognition results of the recognizer 130, and the like. For example, the action plan generator 140 generates a target trajectory along which the vehicle M will travel in the future automatically (without depending on an operation of a driver) so that the vehicle M can basically travel in a recommended lane determined by the recommended lane decider 61 and the vehicle M can cope with a surrounding situation of the vehicle M, on the basis of, for example, shapes of surrounding roads based on a current position of the vehicle M acquired from the recognition result of the recognizer 130 or the map information. The target trajectory includes, for example, a speed element. For example, the target trajectory is represented as a sequence of points (trajectory points) that the vehicle M should reach. The trajectory point is a point that the vehicle M should reach for a predetermined traveling distance (for example, a few meters) along the road, and in addition, the target speed and target acceleration are generated as part of the target trajectory for each predetermined sampling time (for example, a few tenths of a second). In addition, the trajectory point may be the position that the vehicle M should reach at each predetermined sampling time. In this case, information on the target speed and target acceleration is expressed as an interval between trajectory points.

The action plan generator 140 may set automated driving events when generating a target trajectory. Examples of the events include a constant speed driving event in which the vehicle M is driven in the same lane at a constant speed, a follow-up driving event in which the vehicle M follows another vehicle that is located within a predetermined distance (for example, within 100 m) in front of the vehicle M and is closest to the vehicle M, a lane change event that causes the vehicle M to change lanes from its own lane to an adjacent lane, a branching event that causes the vehicle M to move to a lane in a destination direction at a branching point of a road, a merging event that causes the vehicle M to move to a lane of a main road at a merging point, a hands-over event that ends automated driving and switches to manual driving, and the like. Examples of the events may include an overtaking event in which the vehicle M is first caused to change lanes into an adjacent lane, overtake a preceding vehicle in the adjacent lane, and then, change the lanes again to an original lane, and an avoidance event in which the vehicle M executes at least one of braking and steering in order to avoid an obstacle present in front of the vehicle M.

The action plan generator 140, for example, may change an event already determined for a current section to another event, or set a new event for the current section according to a surrounding situation of the vehicle M recognized when the vehicle M is traveling. The action plan generator 140 may change the event already set for the current section to another event, or set a new event for the current section according to an operation of the occupant with respect to the HMI 30. The action plan generator 140 generates a target trajectory according to the set event.

The action plan generator 140 also includes, for example, a determiner 142, a selector 144, and an execution controller 146. The execution controller 146 and the second controller 160 are examples of a “traveling controller”. Details of functions thereof will be described below.

The second controller 160 controls the traveling driving force output device 200, the brake device 210, and the steering device 220 so that the vehicle M passes through the target trajectory generated by the action plan generator 140 at a scheduled time.

The second controller 160 includes, for example, a target trajectory acquirer 162, a speed controller 164, and a steering controller 166. The target trajectory acquirer 162 acquires information on a target trajectory (trajectory points) generated by the action plan generator 140 and stores the information on the target trajectory in a memory (not shown). The speed controller 164 controls the traveling driving force output device 200 or the brake device 210 based on the speed element associated with the target trajectory stored in the memory. The steering controller 166 controls the steering device 220 according to the curvature of the target trajectory stored in the memory. The process of the speed controller 164 and the steering controller 166 is realized, for example, by a combination of feed-forward control and feedback control. For example, the steering controller 166 executes control in combination of feed-forward control based on a curvature of a road in front of the vehicle M and feedback control based on a separation from the target trajectory.

Referring back to FIG. 1, the HMI controller 180 uses the HMI 30 to notify the occupant of predetermined information. The predetermined information includes, for example, information on the traveling of the vehicle M, such as information on the state of the vehicle M and information on traveling control. For example, the information on the state of the vehicle M includes a speed of the vehicle M, an engine speed, a shift position, and the like. The information on the traveling control includes, for example, information for inquiring about whether or not traveling control is executed by automated driving and whether or not automated driving should be started, information on a traveling control situation through automated driving, information on an automation level, information (a hands-over request) for requesting the occupant to execute driving when switching from automated driving to manual driving occurs, and the like. Furthermore, the predetermined information may include information that is not related to the traveling of the vehicle M, such as a television program, contents (for example, movies) stored in a storage medium such as a DVD or the like. The predetermined information may include, for example, information on a current position, a destination, and a remaining amount of fuel of the vehicle M in the automated driving. The HMI controller 180 may output information received by the HMI 30 to the communication device 20, the navigation device 50, the first controller 120, and the like.

Furthermore, the HMI controller 180 may cause the HMI 30 to output inquiry information for the occupant, process results by the first controller 120 and the second controller 160, and the like. The HMI controller 180 may transmit various types of information output by the HMI 30 to a terminal device that is used by a user of the vehicle M via the communication device 20.

The traveling driving force output device 200 outputs a traveling driving force (torque) to the driving wheels so that the vehicle travels. The traveling driving force output device 200 includes, for example, a combination of an internal combustion engine, an electric motor, a transmission, and an electronic control unit (ECU) that controls these. The ECU controls the above-described components in accordance with information input from the second controller 160 or information input from the accelerator pedal of the driving operator 80.

The brake device 210 includes, for example, a brake caliper, a cylinder that transmits a hydraulic pressure to the brake caliper, an electric motor that generates the hydraulic pressure in the cylinder, and a brake ECU. The brake ECU controls the electric motor in accordance with the information input from the second controller 160 or the information input from the accelerator pedal of the driving operator 80 so that brake torque according to a braking operation is output to each wheel. The brake device 210 may include a mechanism configured to transfer the hydraulic pressure generated according to an operation on the brake pedal to the cylinder via a master cylinder as a backup. Further, the brake device 210 is not limited to the configuration described above, but may be an electronically controlled hydraulic brake device that controls the actuator according to information input from the second controller 160 and transmits the hydraulic pressure of the master cylinder to the cylinder.

The steering device 220, for example, includes a steering ECU and an electric motor. The electric motor, for example, applies a force to a rack and pinion mechanism to change the direction of the steered wheels. The steering ECU drives the electric motor in accordance with the information input from the second controller 160 or the information input from the steering wheel of the driving operator 80 to change the direction of the steerable wheels.

### Recognizer and action plan generator

Next, details of functions of the recognizer 130 (the first recognizer 132, the second recognizer 134 and the third recognizer 136) and the action plan generator 140 (the determiner 142, the selector 144 and the execution controller 146) will be described.

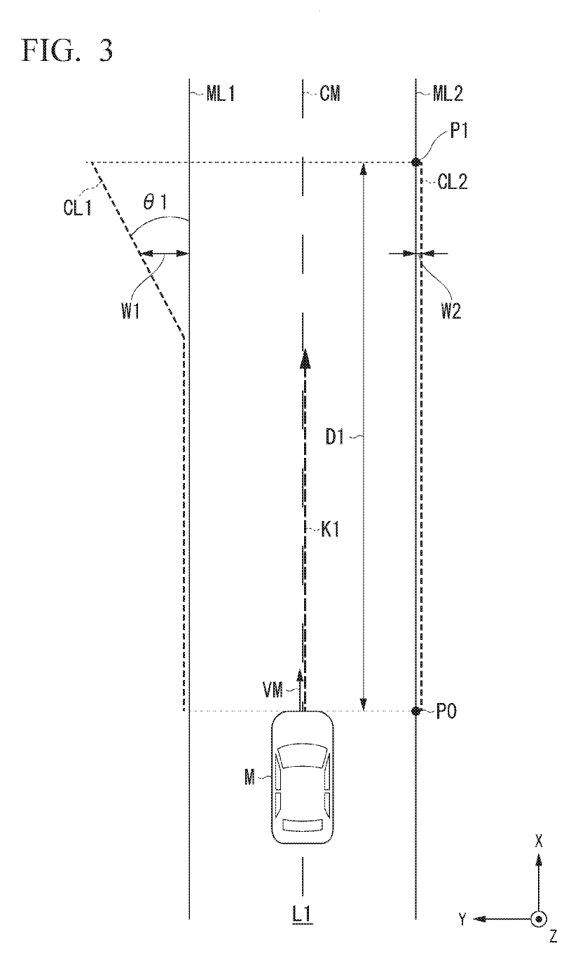

FIG. 3 is a diagram for describing an example of traveling control of the vehicle M according to the embodiment. The example in FIG. 3 shows camera partition lines CL1 and CL2 recognized from an image captured by the camera 10 (hereinafter, referred to as a camera image), and map partition lines ML1 and ML2 obtained from map information (for example, the first map information 54, the second map information 62) on the basis of the position information of the vehicle M. A lane L1 is defined by, for example, the map partition lines ML1 and ML2. The lane L1 shown in FIG. 3 is a lane in which vehicles can travel in an extension direction (an X-axis direction in the drawing). Hereafter, when the camera partition lines CL1 and CL2 are not distinguished from each other, they may be referred to simply as "camera partition line CL," and when the map partition lines ML1 and ML2 are not distinguished from each other, they may be referred to simply as "map partition line ML.” In the scene shown in FIG. 3, the vehicle M is traveling on the lane L1 at a speed VM. If necessary, the lane L1 in which the vehicle M travels may be referred to as a “travel lane L1.” The camera partition line CL is an example of a “first partition line,” and the map partition line ML is an example of a “second partition line.”

In the example in FIG. 3, the vehicle M may be executing, for example, LKAS control. During the execution of LKAS, a target trajectory K1 is generated so that the vehicle M does not deviate from the lane L1 (in other words, so that the vehicle M travels in the center of the lane L1), and traveling control is executed to control at least one of the steering and speed of the vehicle M so that the vehicle M travels along the generated target trajectory K1. In this traveling control, feedforward control and feedback control are executed from time to time on the basis of the target trajectory K1 and the position of the vehicle M to adjust a steering angle, speed, or the like of the vehicle M.

The first recognizer 132 recognizes a surrounding situation including the camera partition line (the first partition line) CL that partitions the lanes present in a surrounding region including the traveling direction of the vehicle M, on the basis of the camera image captured by the camera 10 included in the detection device DD. For example, the first recognizer 132 executes a known analysis process (for example, edge extraction, feature extraction such as color, shape, and size, pattern matching process, character recognition process, and the like) on the camera image and recognizes the camera partition line CL on which the vehicle M travels from the results of the image analysis. When the camera partition line CL is recognized, the first recognizer 132 extracts edge points in the camera image that have a large difference in brightness between adjacent pixels, and recognizes the camera partition line CL on an image plane obtained by connecting the edge points. In addition, the first recognizer 132 converts a position of the camera partition line CL based on a position of a representative point of the vehicle M into a vehicle coordinate system (for example, an XY plane coordinates in which a front direction of the vehicle M is an X axis and a vehicle width direction (a lateral direction) is a Y axis as shown in FIG. 3).

In the example in FIG. 3, the first recognizer 132 recognizes the camera partition lines CL1 and CL2 on the basis of the camera image. In the example in FIG. 3, the camera partition lines CL1 and CL2 that are present within a predetermined distance in front of the vehicle M (in the traveling direction) are shown, but camera partition lines to the side and rear of the vehicle M may also be recognized. In addition, the first recognizer 132 may recognize a curvature of the lane L1 on the basis of the camera image, or may recognize an amount of change in the curvature of the camera partition lines CL1 and CL2. The amount of change in the curvature is, for example, a time change rate of the curvature of the camera partition lines CL1 and CL2 recognized by the camera 10 at a distance of x [m] forward when seen from the vehicle M.

The first recognizer 132 may also recognize target markers (camera target markers) present around (within a predetermined distance) of the vehicle M by the analysis process described above for the camera image, or the like. The target markers include, for example, stationary and moving target markers.

The second recognizer 134 recognizes the map partition line ML that partitions the lane, in which the vehicle M is traveling, from the map information on the basis of the position information of the vehicle M. For example, the second recognizer 134 refers to the map information (the first map information 54, the second map information 62) on the basis of the position information of the vehicle M obtained by the vehicle sensor 40 or the GNSS receiver 51, and recognizes from the map information the map partition line ML that partitions the lane L1 present in the surrounding region including the traveling direction of the vehicle M.

In the example in FIG. 3, the second recognizer 134 recognizes the map partition lines ML1 and ML2 on the basis of the map information. The second recognizer 134 may also recognize the curvature and gradient of the lane L1 from the map information and the amount of change in the curvature of the map partition lines ML1 and ML2.

The second recognizer 134 may also acquire information on target markers (for example, other stationary target markers such as structures) present in front of the vehicle M (in the traveling direction) from the map information.

The third recognizer 136 recognizes target markers around the vehicle M on the basis of, for example, an output of the radar device 12 included in the detection device DD. For example, the third recognizer 136 recognizes target markers (radar target markers) present in the surrounding region including the front of the vehicle M (in the traveling direction) on the basis of the detection results of the radar device 12. The target markers include, for example, stationary and moving target markers. For example, the third recognizer 136 extracts, by clustering, a group of objects that are present within a short distance (within a predetermined distance) from the detection results (the radar object group) of the radar device 12, and recognizes positions (shapes) of the target markers (the radar target markers) present in front (in the traveling direction) or to the side of the vehicle M on the basis of the extraction results. The third recognizer 136 may also recognize distances between the vehicle M and the target markers, directions in which the target markers are present as seen from the vehicle M, and the like.

Further, the third recognizer 136 may recognize the position, distance, direction, or the like of the target markers around the vehicle M on the basis of the detection results by the LIDAR 14 included in the detection device DD, instead of (or in addition to) the radar device 12. By using the radar device 12 or the LIDAR 14, or the like, the third recognizer 136 may also correct the information (the position, and the like) of the target markers detected by the radar device 12 or the LIDAR 14 on the basis of information of the target markers (the camera target markers) recognized by the first recognizer 132. Further, the third recognizer 136 may compare the recognized target markers (the radar target markers) with the camera target markers, and recognize whether the target markers are stationary target markers or moving target markers, or recognize types of the target markers. The third recognizer 136 may also refer to the map information on the basis of the positions of the recognized radar target markers and recognize whether the target markers are already installed objects (for example, structures that do not interfere with (obstruct) traveling) such as a guardrail, elevated road, pedestrian crossing bridge, tunnel, and the like. The recognition results of the third recognizer 136 enable target markers around the vehicle M to be recognized in more detail.

The determiner 142 determines, for example, whether the camera partition line CL recognized by the first recognizer 132 and the map partition line ML recognized by the second recognizer 134 match. “Match” may include a predetermined error tolerance. For example, in a section from a current position of the vehicle M (point P0 in the drawing) to a position (point P1 in the drawing) that is a distance D1 away in the traveling direction (forward), the determiner 142 determines whether the camera partition line CL1 that partitions the left side of the travel lane L1 when seen from the vehicle M matches the map partition line ML1, and determines whether the camera partition line CL2 that partitions the right side of the travel lane L1 matches the map partition line ML2. Here, the distance D1 is, for example, a distance to the farthest point of the camera partition lines CL1 and CL2 that is recognized from the camera image by the first recognizer 132 (or recognition accuracy is less than a threshold value). The distance D1 may be a distance that varies according to a road shape and a speed VM of the vehicle M, or may be a fixed distance determined in advance. A range from a position of the vehicle M (point P0) to point P1, which is the distance D1 away from the position of the vehicle M (point P0), is an example of an effective range (an effective recognition range) within which the camera partition line CL can be recognized by the first recognizer 132.

For example, the determiner 142 compares at least one of the positions, the extension directions (angles), the curvatures, and the amounts of change in the curvature of the camera partition line CL1 and the map partition line ML1, using the effective recognition range based on the distance D1 as a determination target range. For example, the determiner 142 superimposes the camera partition line CL1 and the map partition line ML1 on a plane (an XY plane) of the vehicle coordinate system based on a position of the representative point of the vehicle M, compares lateral positions (a lane width direction, a Y-axis direction in the drawing) of the camera partition line CL1 and the map partition line ML1, and obtains an amount of deviation W1. The amount of deviation W1 may be a maximum amount of deviation in a determination target range, or may be an average value.

The determiner 142 may also compare the extension direction of each of the camera partition line CL1 and the map partition line ML1 and obtain a deviation angle θ1 of the partition lines. The deviation angle θ1 may be a maximum angle of deviation in the determination target range, or may be an average angle. The determiner 142 may also compare the curvature or amount of change in the curvature of the camera partition line CL1 and the map partition line ML1 and obtain a degree (a magnitude) of difference. The determiner 142 may then obtain a degree of discrepancy on the basis of in the amount of deviation W1, the deviation angle θ1, and the degree of difference in the curvature or the amount of change in the curvature. In this case, for example, as the amount of deviation W1 becomes larger, the deviation angle θ1 becomes larger, and the degree of difference in the curvature (the amount of change in the curvature) becomes larger, the degree of discrepancy increases.

Similar to the comparison of the left side partition line, the determiner 142 compares at least one of the position of the camera partition line CL2 and the map partition line ML2 (an amount of deviation W2 in the drawing), the deviation angle, the curvature, and the amount of change in the curvature, and the like, or obtains the degree of discrepancy, as a comparison of the right side partition line in the determination target range. The determiner 142 may obtain the degree of discrepancy between the camera partition line CL and the map partition line ML by comprehensively determining the results of the comparison of the partition line on the left side and the partition line on the right side of the vehicle M (in other words, the travel lane L1).

For example, the determiner 142 determines that the camera partition line CL and the map partition line ML match when both the degree of discrepancy at the left partition line and the degree of discrepancy at the right partition line are less than a threshold value, and determines that the camera partition line CL and the map partition line ML do not match when at least one of them is equal to or greater than the threshold value.

The selector 144 selects at least one of the camera partition lines CL and the map partition line ML for use in the traveling control of the vehicle M on the basis of the determination results by the determiner 142. For example, the selector 144 selects predetermined one or both of the camera partition lines CL and the map partition lines ML when the determiner 142 determines that the camera partition lines CL and map partition lines ML match. The selector 144 selects any one of the camera partition lines CL and the map partition line ML when the determiner 142 determines that the camera partition line CL and the map partition line ML do not match. The function of the selector 144 will be described in detail below. The selector 144 may not select a partition line when the determiner 142 determines that the camera partition line CL and the map partition line ML do not match and a predetermined condition is satisfied.

The execution controller 146 executes control (traveling control) of the vehicle M on the basis of the recognition results of the first and second recognizers 132 and 134, the determination results by the determiner, the selection results by the selector 144, or the like. For example, the execution controller 146 determines the traveling control for the vehicle M on the basis of the above recognition results, determination results, selection results, or the like, and generates a target trajectory K1 based on the determined traveling control. “Determining the traveling control” may include, for example, determining a content (type) of traveling control, or determining whether or not to execute (curb) the traveling control. Furthermore, “executing the traveling control” may include, for example, continuing the traveling control that is already being executed, in addition to switching and executing the content of the traveling control. "Curbing the traveling control" may include not only not executing the traveling control but also lowering a traveling control mode (an automation level).

Here, the traveling control includes a first traveling mode and a second traveling mode that provides a lower degree of driving support than in the first traveling mode or a higher task of the occupant of the vehicle M than in the first traveling mode. The low degree of driving support means, for example, a low automation rate in the traveling control. The low automation rate means, for example, that the automated driving control device 100 has a low degree of control over the steering or speed of the vehicle M (the driver has a high degree of need to intervene in steering or acceleration/deceleration operations). The high task of the occupant includes, for example, a large number of tasks imposed on the occupant or a high level of difficulty of the task. The task includes, for example, monitoring the surrounding situations of the vehicle M, and the occupants operating the driving operator 80. An operation of the driving operator 80 includes, for example, a state in which the driver grips the steering wheel (hereinafter, a hands-on state). The traveling control may include a third traveling mode, or the like, in which the degree of driving support is lower than in the second traveling mode or the task of the occupant of the vehicle M is higher than in the second traveling mode. Further, a traveling mode with the lowest degree of driving support or the highest task for the occupant of the vehicle M may be a fully manual traveling mode (a mode in which the traveling control is not executed).

For example, in the first traveling mode, there is no task for the occupant (or the lightest task), and the traveling control (for example, LKAS, ACC, ALC, TJP, CMBS, or the like) is allowed in a state in which the occupant of the vehicle M does not grip the steering wheel (hereinafter, referred to as a hands-off state). In the second traveling mode, the task imposed on the occupant may include, for example, the hands-on state along with monitoring the surrounding situations of the vehicle M.

For example, the execution controller 146 continues the first traveling mode (for example, the traveling control in the hands-off state) when it is determined that the camera partition line CL and the map partition line ML match while the first traveling mode is being executed. For example, when the execution controller 146 executes LKAS to travel in the center of the travel lane L1 as the first traveling mode, it generates a target trajectory (for example, the target trajectory K1 shown in FIG. 3) for traveling in the center of the lane L1 on the basis of one or both of the camera partition lines CL1 and CL2 and the map partition lines ML1 and ML2 selected by the selector 144, and causes the second controller 160 to execute control so as to travel along the generated target trajectory K1. For example, when any one of the camera partition line CL and the map partition line ML is selected by the selector 144, the execution controller 146 generates the target trajectory K1 on the basis of the left and right positions of the selected one partition line. Further, when the execution controller 146 obtains information on a center line of the lane L1 from the map information, it generates the target trajectory K1 so that the representative point (for example, the center of gravity or the center) of the vehicle M passes over the center line. Furthermore, when both the camera partition line CL and the map partition line ML are selected by the selector 144, the execution controller 146 moves (corrects) the position of one partition line (for example, the map partition line ML) to match the position of the other partition line (for example, the camera partition line CL) and generates the target trajectory K1 using the information on the moved partition line. In the example in FIG. 3, the map partition lines ML1 and ML2 are selected by the selector 144, and the execution controller 146 generates the target trajectory K1 so that the representative point of the vehicle M passes over the center line CM between the map partition lines ML1 and ML2 (or the center line CM of the lane L1 obtained from the map information).

The execution controller 146 may also control switching from the second traveling mode to the first traveling mode when it is determined that the camera partition line CL and the map partition line ML match in the determination target range while the second traveling mode (for example, the driving in the hands-on state) is being executed. In this case, the execution controller 146 may cause the HMI 30 to output information informing the occupant that switching is possible or inquiring whether or not to switch (or information proposing switching) when the switching control is executed, and may switch the traveling mode when information indicating permission for switching is received from the occupant. Further, the execution controller 146 may switch from the second traveling mode to the first traveling mode at a timing when it is determined that the camera partition line CL and the map partition line ML match after an instruction to switch to the first traveling mode is given by the HMI 30.

The execution controller 146 may curb the traveling control in the first traveling mode when it is determined that the camera partition line CL and the map partition line ML do not match in the determination target range and the partition line is not selected by the selector 144. For example, the execution controller 146 executes traveling control to switch from the first traveling mode to the second traveling mode when it is determined that the camera partition line CL and map partition line ML do not match while the first traveling mode is being executed. In this case, the HMI controller 180, for example, causes the HMI 30 to output information (the hands-over request) to request the occupant to drive manually in order to switch to the second traveling mode (for example, from automatic to manual driving). The execution controller 146 may also perform control such that switching to the first traveling mode cannot be executed when it is determined that the camera partition lines CL and the map partition lines ML do not match and the partition line is not selected by the selector 144 while the second traveling mode is being executed.

In addition, when it is determined that the camera partition line CL and the map partition line ML in the determination target range do not match while the first traveling mode is being executed, and the selector 144 selects either the camera partition line CL or the map partition line ML, the execution controller 146 may continue the first traveling mode on the basis of the selected partition line. The execution controller 146 may control switching from the second traveling mode to the first traveling mode on the basis of any one of the camera partition line CL and the map partition line ML selected by the selector 144 when the above conditions are satisfied while the second traveling mode is being executed.

Next, the selection of the partition line by the selector 144 described above will be described. Below, the surrounding situations of the vehicle M at the time of selection will be described in several scenes.

### First scene

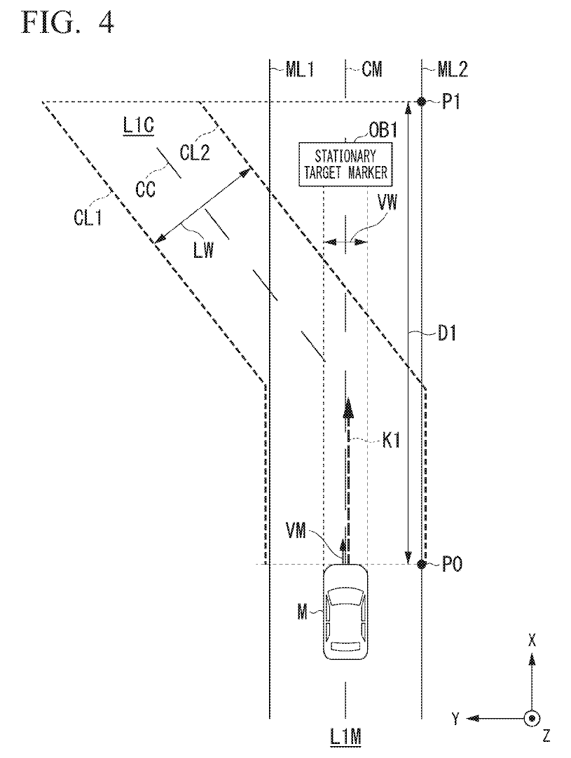

FIG. 4 is a diagram showing an example of a first scene of the surrounding situations. The example in FIG. 4 shows the camera partition lines CL1 and CL2 recognized by the first recognizer 132, the map partition lines ML1 and ML2 recognized by the second recognizer 134, and a stationary target marker OB1 recognized by the third recognizer 136. It is assumed that the stationary target marker OB1 is, for example, an object that is present on a lane (the ground) and has a size (a shape) that the vehicle M cannot pass over (step over) it. The example in FIG. 4 also shows a lane L1C which is partitioned by the camera partition lines CL1 and CL2, and a lane L1M which is partitioned by the map partition lines ML1 and ML2. In the example in FIG. 4, there are overlapping and non-overlapping regions between the lanes L1C and L1M. The lane L1C is an example of a “first lane,” and the lane L1M is an example of a “second lane.” The same applies to the other scenes to be described below.

In the example in FIG. 4, the determiner 142 determines that the partition lines do not match because the degree of discrepancy between the camera partition line CL and the map partition line ML is equal to or greater than a threshold value in the range (the determination target range, the effective recognition range) from a current position (point P0) of the vehicle M to point P1 at a distance D1 ahead (in the traveling direction). In this case, the selector 144 determines reliability (an index value indicating likelihood that the partition line is a correct partition line) of each of the camera partition line CL and the map partition line ML according to whether or not a target marker (for example, a stationary target marker) recognized by the third recognizer 136 is present on each of the lane L1C (the first lane) partitioned by the camera partition lines CL1 and CL2 and the lane L1M (the second lane) partitioned by the map partition lines ML1 and ML2, and selects a partition line for executing (or continuing when currently executing) traveling control of the vehicle M on the basis of the determined reliability. Thus, it is possible to improve accuracy of selection and recognition of the partition lines (travel lanes).

A determination target distance when whether or not a stationary target marker is included in the lane L1M (the second lane) partitioned by the map partition lines ML1 and ML2 is determined should be the same distance as the distance D1 corresponding to the effective recognition range of the camera partition line CL by the first recognizer 132. The same distance allows detection of the presence or absence of the stationary target marker in each of the lanes (the first and second lanes) without being affected by a road shape.

When the distance D1 corresponding to the effective recognition range is less than a predetermined distance, the selector 144 may set the determination target distance to be equal to or greater than the predetermined distance when whether or not a stationary target marker is included in the lane L1M is determined. The above predetermined distance may be, for example, a variable distance according to the speed of the vehicle M and road conditions, or may be a fixed distance. Thus, it is possible to curb the determination results of whether or not a stationary target marker is included in the lane L1M being inappropriate because the determination target distance is too short.

For example, when whether or not a stationary target marker is present on the lane L1C (the first lane) is determined, the selector 144 determines that the stationary target marker is present on the lane L1C (within the effective recognition range) when the stationary target marker is present within a lane width LW of the lane L1C (a width of the lane L1C) shown in FIG. 4, and determines that there is no stationary target marker in the lane L1C (within the effective recognition range) when there is no stationary target marker within the range of the lane width LW. Further, when whether or not a stationary target marker is present on the lane L1M (the second lane) is determined, the selector 144 determines that a stationary target marker is present on the lane L1M when the stationary target marker is present within a range of the width of the vehicle M (the vehicle width VW) included in the lane L1M shown in FIG. 4, and determines that no stationary target marker is present on the lane L1M when no stationary target marker is present within the range of the vehicle width VW. Since the camera partition line CL is recognized from a camera image of an actual travel lane, whereas the map partition line ML is obtained from the map information on the basis of the position information of the vehicle M, there is a high possibility of errors in the position of the lane L1M due to positional errors caused by position sensors or the like. Therefore, as described above, in determining whether or not a stationary target marker is present on the lane L1M, erroneous determinations can be curbed by making a determination range on the lane L1M narrower than the lane width. Further, in the lane L1C, the presence of the stationary target marker can be determined more accurately by setting the determination range to the lane width LW.

The range of the lane width LW described above may be a range obtained by offsetting half a value of the lane width to the left and right based on a center (a center line CC) of the lane L1C obtained from the positions of the camera partition lines CL1 and CL2. Further, the range of the width of the vehicle M (the vehicle width VW) described above may be a range obtained by offsetting half a value of the width of the vehicle M (the vehicle width) to the left and right based on the positions of the map partition lines ML1 and ML2, or a center line CM of the lane L1M obtained from the map information. Thus, since the range can be set based on the center of each of the lanes, even when a shape of the partition line does not follow the actual lane (the travel lane) (for example, even when there is a deviation in part of the partition line), the deviation will not have a significant effect. Therefore, it is possible to determine more accurately whether or not a stationary target marker is present in each range.

In the first scene, it is assumed that the selector 144 has determined that a stationary target marker OB1 is present on the lane L1M and no stationary target marker is present on the lane L1C according to the above determination. In this case, the selector 144 determines that the reliability of the camera partition lines CL1 and CL2 corresponding to the lane L1C is equal to or greater than the threshold value. Further, the selector 144 may also set the reliability of the camera partition lines CL1 and CL2 to a value greater than that of the map partition lines ML1 and ML2. Further, in the case of the first scene, the selector 144 may set the reliability of the map partition lines ML1 and ML2 to be less than the threshold value, and may set the reliability of the map partition lines ML1 and ML2 to a value smaller than that of the camera partition lines CL1 and CL2.

Then, in the first scene, the selector 144 compares the reliabilities of the camera partition line CL and the map partition line ML, and selects the camera partition line CL with the higher reliability. The execution controller 146 generates the target trajectory K1 on the basis of the camera partition lines CL1 and CL2 so that the representative point of the vehicle M passes over the center line CC of the lane L1C partitioned by the camera partition lines CL1 and CL2, and controls the second controller 160 to execute (continue) the traveling control along the generated target trajectory K1. Thus, the traveling control currently being executed (for example, the first traveling mode) can be continued, and it is possible to curb the hands-over request to switch from the first traveling mode to the second traveling mode being output to the occupant. As a result, it is possible to execute more appropriate traveling control.

### Second scene

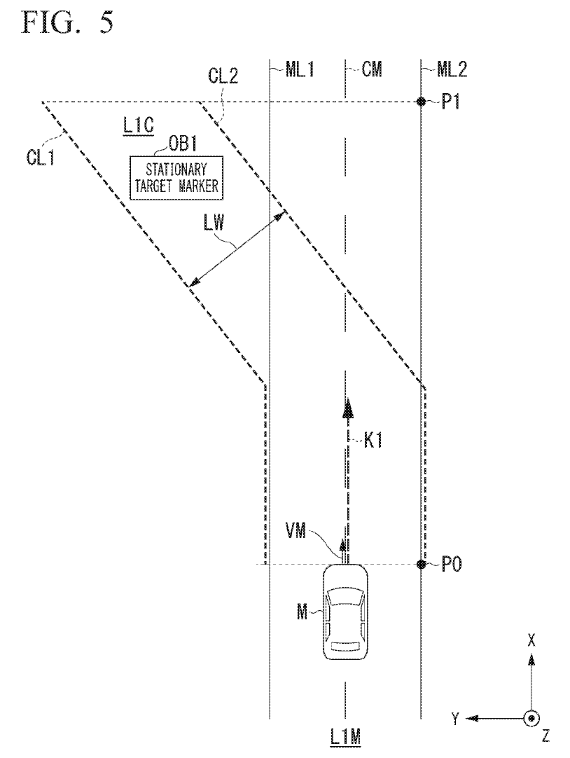

FIG. 5 is a diagram showing an example of a second scene of the surrounding situations. The second scene shown in FIG. 5 differs from the first scene described above in that no stationary target marker OB1 recognized by the third recognizer 136 is present on the lane L1M but on the lane L1C (within the effective recognition range of the lane L1C). The following description will mainly focus on the process based on the above differences, and a description of other processes (the process that overlaps that in the first scene) will be omitted.

In the second scene, the selector 144 determines that no stationary target marker is present on the lane L1M according to the above determination, and that the stationary target marker OB1 is present on the lane L1C (within the range of the lane width LW). In this case, the selector 144 determines that the reliability of the map partition lines ML1 and ML2 corresponding to the lane L1M is equal to or greater than the threshold value. Further, the selector 144 may also set the reliability of the map partition lines ML1 and ML2 to a value greater than that of the camera partition lines CL1 and CL2. Furthermore, in the case of the second scene, the selector 144 may set the reliability of the camera partition lines CL1 and CL2 to be less than the threshold value, and the reliability of the camera partition lines CL1 and CL2 to a value smaller than that of the map partition lines ML1 and ML2.

Then, in the second scene, the selector 144 compares the reliabilities of the camera partition line CL and the map partition line ML, and selects the map partition line ML with the higher reliability. The execution controller 146 generates the target trajectory K1 so that the representative point of the vehicle M passes over the center line CM of the lane L1M, and controls the second controller 160 to execute (continue) traveling control along the generated target trajectory K1.

For example, when the second scene occurs after it has already been determined that the reliability of the map partition lines ML1 and ML2 is less than the threshold value (a value smaller than that of the camera partition line CL), the selector 144 may determine that the determination that the reliability of the map partition lines ML1 and ML2 is less than the threshold value (a value smaller than that of the camera partition line CL) is incorrect (a misrecognition). In this case, the selector 144 may adjust the reliability of the map partition lines ML1 and ML2 and the camera partition lines CL1 and CL2 back to the reliability before the previous determination, or may adjust the reliability of the camera partition lines CL1 and CL2 to a value even lower than the reliability before the previous determination. The selector 144 then compares the reliabilities of the camera partition line CL and the map partition line ML, and selects the partition line with the higher reliability. Thus, it is possible to adjust the reliability according to the presence of the stationary target marker and to select more appropriate partition lines (more correct partition lines) according to the adjusted reliability.

### Third scene

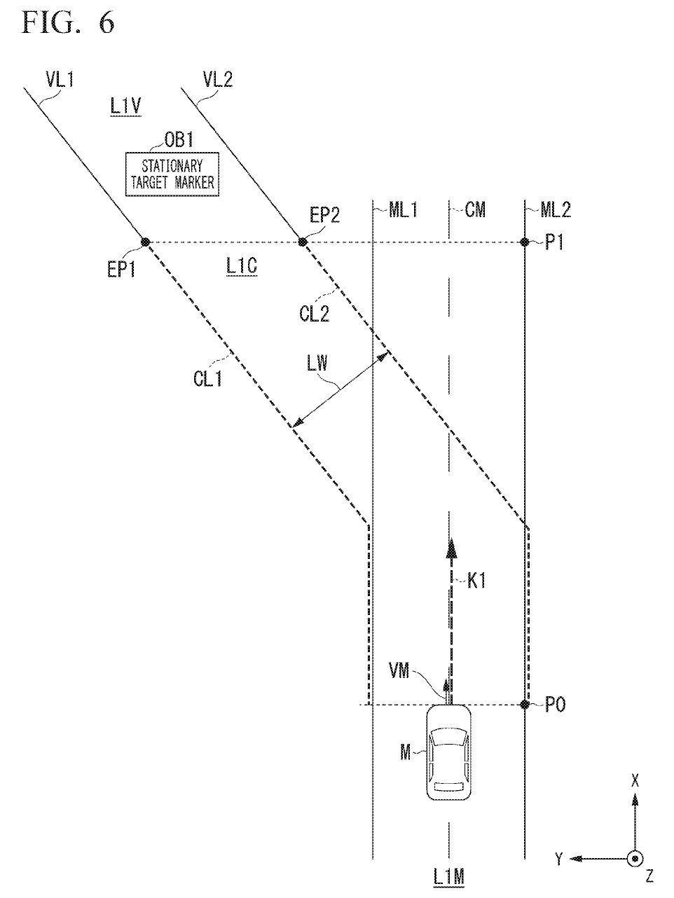

FIG. 6 is a diagram showing an example of a third scene of the surrounding situations. The third scene shown in FIG. 6 differs from the second scene described above in that the position of the stationary target marker OB1 recognized by the third recognizer 136 is not present within the effective recognition range of the camera partition lines CL1 and CL2, but outside the effective recognition range. In other words, in the third scene, the recognition results by the first recognizer 132 show that no stationary target marker OB1 is recognized as the camera target marker, but the stationary target marker OB1 is recognized by the third recognizer 136 which has a larger effective recognition range than in the first recognizer 132. The following description will mainly focus on the process based on the above differences, and a description of other processes will be omitted.

In the third scene, when it is determined that no stationary target marker is present within the effective recognition range of the lane L1C, the selector 144 determines whether or not the stationary target marker is present on a lane L1V (a virtual lane) partitioned by virtual lines VL1 and VL2 that respectively extend further away from far end portions EP1 and EP2 of the camera partition lines CL1 and CL2 (far end portions when seen from the vehicle M) in the extension direction of the camera partition lines CL1 and CL2. When whether or not a stationary target marker is present on the lane L1V is determined, it is determined that the stationary target marker is present on the lane L1V (outside the effective recognition range) when the stationary target marker is present within the range of the lane width LW of the lane L1V (that is, the width of the lane L1V which is the same width as the width of the lane L1C), and it is determined that no stationary target marker is present on the lane L1V (outside the effective recognition range) when no stationary target marker is present within the range of the lane width LW. In the example of FIG. 6, the selector 144 determines that the stationary target marker is present outside the effective recognition range of the camera partition line CL, because the stationary target marker OB1 is present on the lane L1V.

In the third scene, when the selector 144 determines that a stationary target marker is present outside the effective recognition range of the camera partition line CL, the reliability of the camera partition line CL is set to a value smaller than the reliability when it is determined that no stationary target marker is present both within the effective recognition range and outside the effective recognition range.

For example, when the situation like the third scene occurs after it has already been determined that the reliability of the map partition lines ML1 and ML2 is less than the threshold value (a value smaller than that of the camera partition line CL), the selector 144 may determine that the determination that the reliability of the map partition lines ML1 and ML2 is less than the threshold value (the value smaller than that of the camera partition line CL) is correct. In this case, the selector 144 may adjust the reliability of the map partition lines ML1 and ML2 to a value even smaller than the current reliability.

In the third scene, in a state in which it is determined that the reliability of the map partition lines ML1 and ML2 is less than the threshold value (the value smaller than that of the camera partition line CL), it is determined that a stationary target marker is present outside the effective recognition range of the camera partition line CL, and when the reliability of the camera partition line CL is less than the threshold value, the selector 144 may not select either the camera partition line CL or the map partition line ML. In this case, the execution controller 146 curbs the first traveling mode being executed. Therefore, when the first traveling mode is being executed, the hands-over request is output to the occupant to execute the second traveling mode, and control is executed to switch to the second traveling mode when the occupant is in a state in which they can execute manual driving (for example, in the hands-on state while monitoring the surrounding situations).

As shown in the second and third scenes described above, when the camera partition line CL and the map partition line ML do not match, the reliability of the partition line is adjusted according to whether or not the position of the stationary target marker recognized by the third recognizer 136 is within the effective recognition range of the camera partition line CL, and thus, for example, even when an incorrect determination is made due to information with reduced recognition accuracy, the reliability can be adjusted, and a more appropriate partition line can be selected based on the adjusted reliability.

In the embodiment, the recognition process by the recognizer 130 (the first recognizer 132, the second recognizer 134, and the third recognizer 136) is executed repeatedly, for example, in a predetermined cycle. Therefore, the third recognizer 136 repeatedly executes recognition of the stationary target markers at a predetermined cycle. In addition, the third recognizer 136 may recognize the reliability of the recognized stationary target marker (an index value indicating likelihood that the stationary target marker is actually present; hereinafter, referred to as “stationary target marker reliability”). For example, the third recognizer 136 adjusts the stationary target marker reliability on the basis of results of continuously recognizing the stationary target markers at each predetermined cycle, for example, according to whether or not the stationary target marker is present at the same position, or according to a degree of change in shape. In this case, as the repeatedly recognized stationary target markers are in the same positions or as the degree of change in shape becomes smaller, the stationary target marker reliability increases. Further, when the number of times the third recognizer 136 recognizes a state in which the stationary target marker reliability is less than the threshold value is equal to or greater than a predetermined number of times, it determines that the recognized stationary target marker is erroneous (a misrecognition) and dismisses the presence of the stationary target marker (it is assumed that no stationary target marker is present). The predetermined number of times is multiple times (for example, four times, or the like). Further, the predetermined number of times may be the number of consecutive times (the number of consecutive recognitions) that the stationary target reliability is less than the threshold value.

In a situation in which the recognition process of the third recognizer 136 described above is being executed, the selector 144 determines the reliability of the camera partition line CL and the map partition line ML on the basis of the stationary target marker at a timing when a predetermined period (for example, a period based on a time or a period based on a traveled distance) has elapsed since the stationary target marker was first recognized by the third recognizer 136. Therefore, at the end of the predetermined period, even when the reliability of the stationary target marker is less than the threshold value, the number of times has not yet reached the predetermined number, and thus the presence of the stationary target marker may not be dismissed. Therefore, the selector 144 may not use the stationary target marker for determining the reliability of the camera partition line CL and the map partition line ML even after a predetermined period has elapsed when the number of times that the stationary target marker is recognized to be in a state in which the reliability thereof is less than the threshold value is less than a predetermined number greater than 0 (zero) at the end of the predetermined period. In this case, the selector 144 uses the stationary target marker to determine the reliability of the camera partition line CL or the map partition line ML when, after a predetermined period has elapsed, it is determined that the stationary target marker reliability is equal to or greater than the threshold value (the stationary target marker is effective).

Thus, it is possible to curb the use of the stationary target markers (the stationary target markers of which the reliability is less than the threshold value) in the middle of the dismissal determination to determine the reliability of the camera partition lines CL and map partition lines ML. Therefore, erroneous determination of the reliability of the partition lines can be curbed, more appropriate partition lines can be selected, and thus more appropriate traveling control can be executed using the selected partition lines.

Further, in the embodiment, whether or not the recognized map partition line ML is correct may also be determined by the presence or absence of the stationary target markers on the lanes L1C and L1M. For example, the selector 144 may determine that the map partition line ML is likely to be correct when it determines that the stationary target marker OB1 is present on the lane L1C, as shown in FIG. 5. Further, as shown in FIG. 6, the selector 144 may determine that the map partition line ML is likely to be erroneous when it determines that the stationary target marker OB1 is outside the effective recognition range and that the stationary target marker OB1 is on the lane L1V partitioned by the virtual lines VL1 and VL2 described above. Thus, it is possible to evaluate the map partition line ML according to whether or not the position of the stationary target marker recognized by the third recognizer 136 is within the effective recognition range of the camera partition line CL by the first recognizer 132, and to select the partition line on the basis of the evaluation result.

Further, in the embodiment, when it is determined that the stationary target markers are present on both the lane L1C and the lane L1M, the selector 144 reduces the reliability of both the camera partition line CL and the map partition line ML (below the threshold value) and does not select any partition line. In this case, the execution controller 146 curbs the execution of the first traveling mode. Further, since there is a possibility that the recognized camera partition lines CL and map partition lines ML are both misrecognized, the HMI controller 180 may cause the HMI 30 to output an alert or the like to the occupants in addition to outputting the hands-over request or the like.

### Modification examples

In the embodiment described above, a condition () for executing a process of determining whether or not a stationary target marker is present on the lane L1C and on the lane L1M may include that the stationary target marker recognized by the third recognizer 136 is not a structure that does not interfere with (obstruct) traveling (for example, an elevated road or pedestrian crossing bridge that crosses over the lane).

Further, the condition for executing the above process may include that there is no tunnel (including a structure similar to a tunnel) within a predetermined distance in the traveling direction of the vehicle M, or that the vehicle M is not traveling inside a tunnel. Information on structures such as tunnels is obtained, for example, from the recognition results by the first recognizer 132 or by referring to the map information on the basis of the position information of the vehicle M. Since the presence of structures such as tunnels reduces the accuracy of recognition by the third recognizer 136 using a radar, the accuracy of determining the reliability can be further improved by not determining whether or not the stationary target marker is present on the lane L1C and the lane L1M when traveling near a tunnel.

The condition for executing the above process may include that no preceding vehicle is present in front of the vehicle M (in the traveling direction). When there is a preceding vehicle in front of the vehicle M, the selector 144 may determine the reliability of the camera partition lines CL and the map partition lines ML on the basis of a positional relationship between the camera partition line CL and the map partition line ML, and a traveling trajectory and a predicted future route of the preceding vehicle. In this case, the selector 144 increases the reliability of one of the camera partition line CL and the map partition line ML that extends along the traveling trajectory and the predicted future route of the preceding vehicle. Further, the selector 144 may also reduce the reliability of the partition line that may come into (or be in) contact with the traveling trajectory and the predicted future route of the preceding vehicle.

In the embodiment described above, it was determined whether or not the camera partition line CL and the map partition line ML match, but instead of match or not, it may be determined whether or not there is no discrepancy. In this case, the determiner 142 determines that there is a discrepancy when the degree of discrepancy is equal to or greater than the threshold value, and determines that there is no discrepancy when the degree of discrepancy is less than the threshold value.

### Process flow

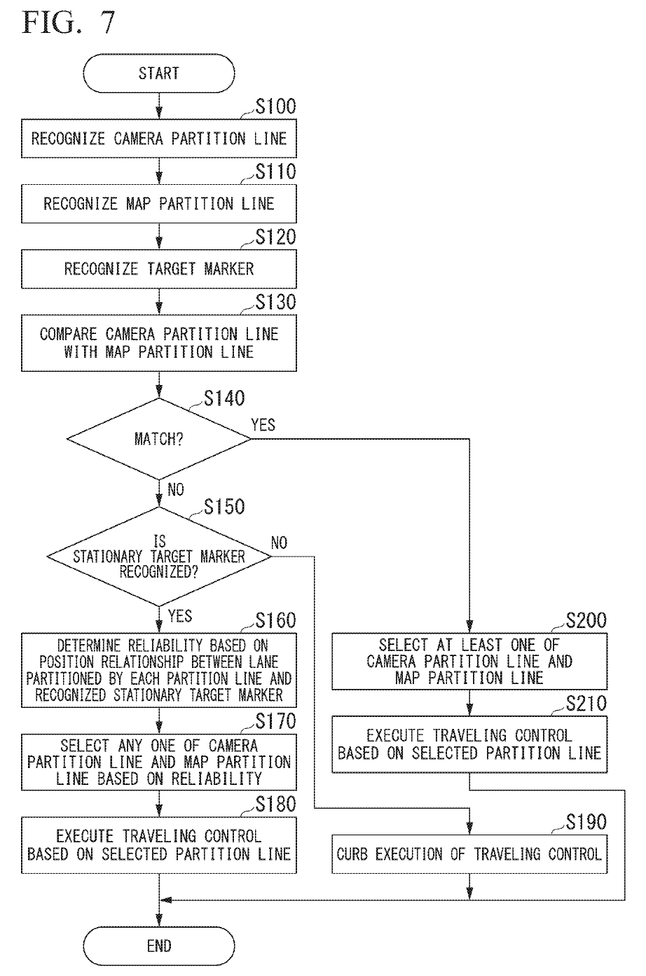

Hereinafter, a process executed by the automated driving control device 100 of the embodiment will be described. FIG. 7 is a flowchart showing an example of a flow of a process executed by the automated driving control device 100. The following description will focus on a driving control process, among the processes executed by the automated driving control device 100 that is based mainly on a recognition status of partition lines, and the like. A process to be described below may be repeatedly executed at a predetermined timing or a predetermined cycle, and may be repeatedly executed while the driving control of the automated driving control device 100 is being executed.

In the example of FIG. 7, the first recognizer 132 recognizes the partition line (the camera partition line CL) present around the vehicle M on the basis of the camera image captured by the camera 10 (Step S100). Next, the second recognizer 134 refers to the map information on the basis of the position information of the vehicle M to recognize the partition line (the map partition line ML) present around the vehicle M from the map information (Step S110). Next, the third recognizer 136 recognizes target markers present around the vehicle M (Step S120). Each of Steps S100 to S120 may be performed in an order different from that described above.

Next, the determiner 142 compares the camera partition line CL with the map partition line ML (Step S130), and determines whether or not the camera partition line CL and the map partition line ML match (Step S140). When it is determined that the camera partition line CL and the map partition line ML do not match, the selector 144 determines whether or not a stationary target marker is recognized around the vehicle M with the third recognizer 136 (Step S150). When it is determined that a stationary target marker is recognized, the selector 144 determines the reliability of each of the partition lines on the basis of the positional relationship (for example, whether or not a stationary target marker is present on each lane) between the lanes (for example, a first lane and a second lane) partitioned by the camera partition line CL and the map partition line ML and the recognized stationary target marker is determined (Step S160).

Next, the selector 144 selects any one of the camera partition line CL and map partition line ML on the basis of the determined reliability (Step S170). Next, the execution controller 146 generates a target trajectory on the basis of the selected partition line and causes the second controller 160 to execute (or continue when in execution) the traveling control (for example, traveling control in the first traveling mode) on the basis of the generated target trajectory (Step S180).

Further, when it is determined in the process of Step S150 that no stationary target marker is recognized, the selector 144 does not select a partition line, and the execution controller 146 curbs the execution of the traveling control (Step S190).

Further, when it is determined in the process of Step S140 that the camera partition line CL and the map partition line ML match, the selector 144 selects at least one of the camera partition line CL and the map partition line ML (Step S200). Next, the execution controller 146 generates a target trajectory on the basis of the selected partition line and causes the second controller 160 to execute the traveling control on the basis of the generated target trajectory (Step S210). Accordingly, the process of this flowchart ends. In the process of Step S150 described above, when it is determined that no stationary target marker is recognized, instead of the process of Step S190, the selector 144 compares the camera partition line CL with the map partition line ML, and when the degree of discrepancy is equal to or greater than a threshold value, the camera partition line CL is selected and the process may proceed to Step S180, and when it is less than the threshold value, the process may proceed to Step S200.

According to the embodiment described above, the automated driving control device 100 (an example of the traveling control device) includes a first recognizer 132 that recognizes a surrounding situation including a camera partition line CL (an example of a first partition line) that partitions lanes around a vehicle M from an image captured by a camera 10 (an example of an imaging part), a second recognizer 134 that recognizes a map partition line ML (an example of a second partition line) that partitions the lanes around the vehicle M from map information on the basis of position information of the vehicle M, a third recognizer 136 that recognizes a target marker around the vehicle M on the basis of an output of a radar device 12, a determiner 142 that determines whether or not the camera partition line CL and the map partition line ML match, a selector 144 that selects any one of the camera partition line CL and the map partition line ML when the determiner 142 determines that the camera partition line CL and the map partition line ML do not match, and a traveling controller (an execution controller 146, a second controller 160) that executes traveling control of the vehicle M on the basis of the partition line selected by the selector 144, and the selector 144 determines reliability of each of the camera partition line CL and the map partition line ML according to whether or not a stationary target marker recognized by the third recognizer 136 is present in a first lane partitioned by the camera partition line CL and a second lane partitioned by the map partition line ML, and selects either the camera partition line CL or the map partition line ML on the basis of the reliability, thereby enabling more appropriate traveling control to be executed on the basis of recognition results of the surrounding situation. This can ultimately contribute to development of a sustainable transportation system.

For example, according to the embodiment, when the camera partition line CL and the map partition line ML do not match, the reliability of each of the partition lines can be determined using the stationary target marker around the vehicle M obtained from the radar device 12, thereby further improving the accuracy of selecting a travel lane (or recognizing the partition lines). Therefore, even when the camera partition line CL and the map partition line ML do not match while the vehicle M is in the first traveling mode (the hands-off state), the traveling control such as the first traveling mode can be executed (or continued when it is being executed) on the basis of the selected partition line, and thus it is possible to curb an output of the hands-over request and the like, and to further improve continuity of the traveling control.

The embodiment described above can be expressed as below.

A traveling control device includes a storage medium configured to store computer-readable instructions, and

a processor connected to the storage medium, and

the processor executes the computer-readable instructions to

recognize a surrounding situation including a first partition line that partitions a lane around a vehicle from an image captured by an imaging part,

recognize a second partition line that partitions a lane around the vehicle from map information on the basis of position information of the vehicle,

recognize a target marker around the vehicle on the basis of an output of a radar device,

determine whether or not the first partition line and the second partition line match,

select any one of the first partition line and the second partition line when it is determined that the first partition line and the second partition line do not match,

execute traveling control of the vehicle on the basis of the selected partition line, and

determine reliability of each of the first partition line and the second partition line according to whether or not a stationary target marker is present on a first lane partitioned by the first partition line and a second lane partitioned by the second partition line, and select any one of the first partition line and the second partition line on the basis of the reliability.

As above, although a form for executing the present invention has been described using the embodiment, the present invention is not limited to such an embodiment at all, and various modifications and substitutions can be applied within a range not departing from the concept of the present invention.

What is claimed is:

1. A traveling control device comprising:
a first recognizer configured to recognize a surrounding situation including a first partition line that partitions a lane around a vehicle from an image captured by an imaging part;
a second recognizer configured to recognize a second partition line that partitions a lane around the vehicle from map information on the basis of position information of the vehicle;
a third recognizer configured to recognize a target marker around the vehicle on the basis of an output of a radar device;
a determiner configured to determine whether or not the first partition line and the second partition line match;
a selector configured to select any one of the first partition line and the second partition line when the determiner determines that the first partition line and the second partition line do not match; and
a traveling controller configured to execute traveling control of the vehicle on the basis of the partition line selected by the selector,
wherein the selector determines reliability of each of the first partition line and the second partition line according to whether or not a stationary target marker recognized by the third recognizer is present on a first lane partitioned by the first partition line and a second lane partitioned by the second partition line, and selects any one of the first partition line and the second partition line on the basis of the reliability.

2. The traveling control device according to claim 1, wherein, after it is determined that the reliability of the second partition line is less than a threshold value,
the selector determines that a determination that the reliability of the second partition line is less than the threshold value is correct when the stationary target marker is present outside an effective recognition range of the first recognizer and the stationary target marker is present on a lane partitioned by a virtual line that extends from a far end portion of the first partition line when seen from the vehicle.

3. The traveling control device according to claim 2, wherein after it is determined that the reliability of the second partition line is less than the threshold value,
the selector determines that the determination that the reliability of the second partition line is less than the threshold value is erroneous when the stationary target marker is present within the effective recognition range of the first recognizer.

4. The traveling control device according to claim 1, wherein the selector,
determines that the second partition line is likely to be correct when the stationary target marker is present within an effective recognition range of the first recognizer, and
determines that the second partition line is likely to be erroneous when the stationary target marker is present outside the effective recognition range of the first recognizer and the stationary target marker is present on a lane partitioned by a virtual line that extends from a far end portion of the first partition line when seen from the vehicle.

5. The traveling control device according to claim 1, wherein the selector sets a determination target distance for determining whether or not the stationary target marker is present in the second partition line to be the same as a distance corresponding to an effective recognition range of the first recognizer when whether or not the stationary target marker recognized by the third recognizer is present on the first lane and the second lane is determined.

6. The traveling control device according to claim 5, wherein when the distance corresponding to the effective recognition range of the first recognizer is less than a predetermined distance, the selector sets the determination target distance to be equal to or greater than the predetermined distance.

7. The traveling control device according to claim 1, wherein in a case in which it is determined whether or not the stationary target marker recognized by the third recognizer is present on the first lane and the second lane,
the selector determines that the stationary target marker is present on the first lane when whether or not the stationary target marker is present on the first lane is determined and the stationary target marker is present within a range of a lane width of the first lane, and
determines that the stationary target marker is present on the second lane when whether or not the stationary target marker is present on the second lane is determined and the stationary target marker is present within a range of a vehicle width of the vehicle.

8. The traveling control device according to claim 7, wherein the range of the lane width is a range offset by half a value of the lane width from a center of the first lane partitioned by the first partition line, and
the range of the vehicle width of the vehicle is a range offset by half a value of the vehicle width from a center of the second lane partitioned by the second partition line.

9. The traveling control device according to claim 1, wherein the third recognizer
repeatedly recognizes the stationary target marker at a predetermined cycle, and
dismisses presence of the stationary target marker when the number of times that the reliability of the recognized stationary target marker is determined to be less than a threshold value reaches a predetermined number greater than 0, and
the selector
determines the reliability of the first partition line and the second partition line on the basis of the stationary target marker after a predetermined period has elapsed since the stationary target marker is recognized by the second recognizer, and
uses the stationary target marker to determine the reliability of the first partition line and the second partition line when the number of times that the reliability of the stationary target marker is determined to be less than a threshold value is less than a predetermined number after the predetermined period has elapsed, and when it is determined that the reliability of the stationary target marker is equal to or greater than a threshold value after the predetermined period has elapsed.

10. A traveling control method comprising:
recognizing, by a computer, a surrounding situation including a first partition line that partitions a lane around a vehicle from an image captured by an imaging part;
recognizing, by the computer, a second partition line that partitions a lane around the vehicle from map information on the basis of position information of the vehicle;
recognizing, by the computer, a target marker around the vehicle on the basis of an output of a radar device;
determining, by the computer, whether or not the first partition line and the second partition line match;
selecting, by the computer, any one of the first partition line and the second partition line when it is determined that the first partition line and the second partition line do not match;
executing, by the computer, traveling control of the vehicle on the basis of the selected partition line; and
determining, by the computer, reliability of each of the first partition line and the second partition line according to whether or not a stationary target marker is present on a first lane partitioned by the first partition line and a second lane partitioned by the second partition line, and selecting, by the computer, any one of the first partition line and the second partition line on the basis of the reliability.

11. A computer-readable non-transitory storage medium storing a program causing a computer to:
recognize a surrounding situation including a first partition line that partitions a lane around a vehicle from an image captured by an imaging part;
recognize a second partition line that partitions a lane around the vehicle from map information on the basis of position information of the vehicle;
recognize a target marker around the vehicle on the basis of an output of a radar device;
determine whether or not the first partition line and the second partition line match;
select any one of the first partition line and the second partition line when it is determined that the first partition line and the second partition line do not match;
execute traveling control of the vehicle on the basis of the selected partition line; and
determine reliability of each of the first partition line and the second partition line according to whether or not a stationary target marker is present on a first lane partitioned by the first partition line and a second lane partitioned by the second partition line, and selects any one of the first partition line and the second partition line on the basis of the reliability.
